(19) United States
(12) Patent Application Publication
(10) Pub. No.: US 2006/0126684 A1
(43) Pub. Date: Jun. 15, 2006

(54) Real time constant excitation ratio (ER) laser driving circuit

(76) Inventors: Chien-Chang Liu, Sunnyvale, CA (US); HengJu Cheng, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/008,905

(22) Filed: Dec. 10, 2004

(51) Int. Cl. H01S 3/00

(52) U.S. Cl. 372/38.07

(57) ABSTRACT

Adverse effects to laser excitation ratio slope caused for example by ambient temperature maybe compensated for by adjusting drive current to the laser. The real time excitation ratio slope may be determined by dithering the code word by +/−1 least significant bit (LSB) of a digital-to-analog drive current source (DAC). A slight variation in laser output power caused by the dither may be detected and used to calculate in real time the laser excitation ratio slope. This may be used to select a drive current to compensate for ambient changes keeping the excitation ratio slope substantially constant.

### FIELD OF THE INVENTION

Embodiments of the present invention relate to lasers and, more particularly, to monitoring and controlling a laser in real time.

### BACKGROUND INFORMATION

Lasers are used in a wide variety of applications. In particular, lasers are integral components in optical communication systems where a beam modulated with vast amounts of information may be communicated great distances at the speed of light over optical fibers as well as short reach distances such as from chip-to-chip in a computing environment.

Of particular interest is the so-called vertical cavity surface emitting laser (VCSEL). As the name implies, this type of laser is a semiconductor micro-laser diode that emits light in a coherent beam orthogonal or “vertical” to the surface of a fabricated wafer. VCSELs are compact, relatively inexpensive to fabricate in mass quantities, and may offer advantages over edge emitting lasers which currently comprise the majority of the lasers used in today's optical communication systems. The more traditional type edge emitting laser diodes emit coherent light parallel to the semiconductor junction layer. In contrast, VCSELs emit a coherent beam perpendicular to the boundaries between the semiconductor junction layers. Among other advantages, this tends to make it easier to couple the light beam to an optical fiber.

VCSELs may be efficiently fabricated on wafers using standard microelectronic fabrication processes and, as a result, may be integrated on-board with other components. VCSELs may be manufactured using, for example, aluminum gallium arsenide (AlGaAs), gallium arsenide (GaAs), indium gallium arsenide nitride (InGaAsN), or similarly suited materials. VCSELS have been successfully manufactured in 850 nm, 1310 nm and 1550 nm ranges. This allows for a wide variety of fiber optic applications ranging from short reach applications to long haul data communications. VCSELs are promising to advance optical communication systems by providing a fast, inexpensive, energy efficient, and more reliable source of laser beam generation.

Optical transceivers using VCSELs operating at line rates of 10 gigabits/second (Gb/s) have matured rapidly over the last few years and are currently available in a wide variety of form factors, each addressing a range of link parameters and protocols. These form factors are the result of Multi-Source Agreements (MSAs) that define common mechanical dimensions and electrical interfaces. The first MSA was the 300-pin MSA in 2000, followed by XENPAK, X2/XPAK, and XFP. Each of the transceivers defined by the MSAs has unique advantages that fit the needs of various systems, supporting different protocols, fiber reaches, and power dissipation levels.

Temperature affects the performance of VCSELs. Nevertheless, optical transceivers are expected to operate across a wide ambient temperature range. For example, some of the MSAs may call for the transceiver to operate in conditions as cold as −25° Celsius to as hot as 85° Celsius. In optical transceiver circuits, one common problem encountered may be the change of laser ER (extinction ratio) with temperature changes. When electrons at energy level N₁ are moved to higher energy level, N₂, energy is absorbed. When the electrons at energy level N₂ drop to level N₁, light is emitted. The ratio of electron quantity n₂ at energy level N₂ to a total electron quantity (n1+n2) at energy levels N1 and N2 may be called the excitation ratio (ER).

VCSELs have the ER characteristics as shown in FIG. 1. At lower temperatures, the slope efficiency is high. As the ambient temperature increases to higher temperatures, the slope efficiency drops and the turn on threshold current also increases. In order to compensate for this effect, the laser driving current may be increased as temperature rises.

One way to determine the amount by which to modify drive current for a given temperature change may be to record the laser driving conditions in a memory (e.g. an EEPROM) for different temperature conditions. A driver determines the level of current to provide by referencing the look-up table in the memory to thus to compensate for the drop in slope efficiency. However, in real-world manufacturing, the manufacturer may only have one look up table to fit all different laser characteristics, which may vary due to operating conditions, age, and manufacturing variances. Hence, a laser using a “one size fits all” look-up table to determine operating conditions may tend to be inaccurate.

### BRIEF DESCRIPTION OF THE DRAWINGS

FIG. 1 graph plotting laser power vs. drive current illustrating the change in excitation ratio (ER) slope for a vertical cavity surface emitting laser (VCSEL) operating in a lower temperature and higher temperature;

FIG. 2 is a plan view of a small form factor (SFF) optical transceiver package according to embodiments of the invention;

FIG. 3 is a cut-away side view of a transmitter optical sub-assembly (TOSA) which may comprise the transmitter portion of the SFF shown in FIG. 2;

FIG. 4 is a plan view of a TO-can comprising part of the TOSA;

FIG. 5 is a block diagram showing the drive control for the TOSA;

FIG. 6 is a graph illustrating periodically increasing and decreasing the current code to a digital-analog current (DAC) source by +/−1 least significant bit (LSB) to determine the excitation ratio of a VCSEL in real time;

FIG. 7 is a block diagram of a parallel optics module implementing one embodiment of the invention; and

FIG. 8 is a block diagram of an optical router implementing the VCSEL and control scheme in one embodiment of the invention.

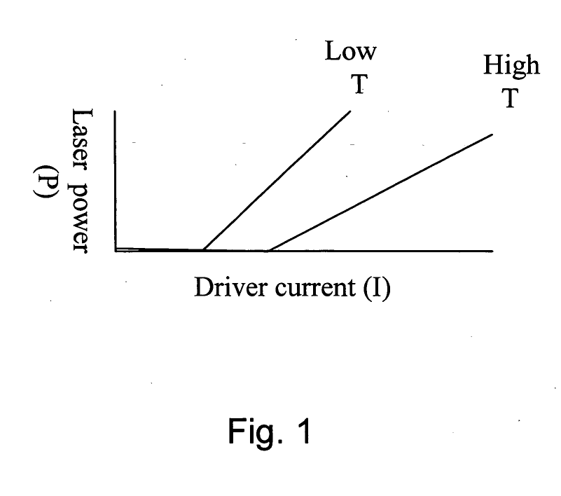

### DETAILED DESCRIPTION

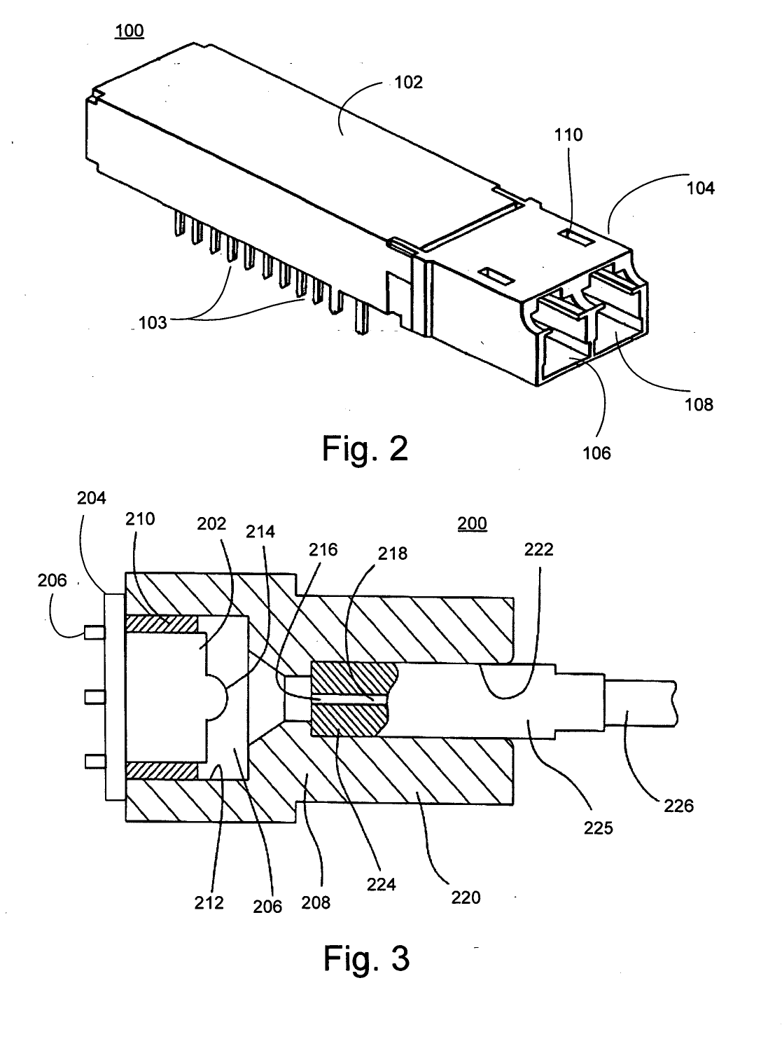

Modern Small Form Factor (SFF) Optical Transceivers provide high performance integrated duplex data links for bi-directional communication over multimode optical fiber. FIG. 2 shows one type of an SFF optical transceiver package 100. The package may comprise a body 102 for housing electronic and optoelectronic components. Pins 103 may be provided on the body 102 for attachment to a circuit board. The front of the package 100 may include a receptacle portion 104 to receive a mating plug (not shown) to connect optical fibers or waveguides to the transceiver package 100. In this example a transmitter receptacle 106 and a receiver receptacle 108 are shown. Slots 110 or similar features may be present to provide a locking mechanism for a mating plug.

Referring to FIG. 3, within the transmitter receptacle 106 of FIG. 2, there may be a transmitter optical sub-assembly (TOSA) 200. While the TOSA may take many configurations, the one illustrated in FIG. 2 comprises what may be known as a transistor-outline can (TO-can) package 202. This name refers to the shape of the TO-can 202 that resembles the shape of a discrete transistor package. The TO-can 202 hermetically houses sensitive components of the TOSA 200. The TO-can 202 may comprise a header portion 204 having electrical leads 206. The TO-can 202 fits within a cavity 206 with the header 204 abutting against an outer housing 208. A spacer 210 may be used to hold the TO-can 202 against the inner walls 212 of the cavity 206. A lens or window 214 in the top of the TO-can 202 allows light to pass to or from and optical fiber core 216. The housing 208 is adapted to align the optical fiber 218 to the window 214 of the TO-can 202. While the TO-can 202 is shown as a convex lens 214, the TO-can 202 may comprise a metal can with a flat angled window. The housing 208 may form the female portion 220 of a small form factor (SFF) pluggable connector, such as an LC connector, or other standardized removable connector for optical transceivers. The fiber 218 has an extending cord section 226 and may further comprise an outer protective sheathing 224 that is held by the mating portion of the connector comprising a ferrule 225 centering the fiber 218. The ferrule 225 may be plugged into a ferrule receptacle 222 formed in the housing 208 such that the fiber 218 is optically aligned with the window 214 of the TO-can 202.

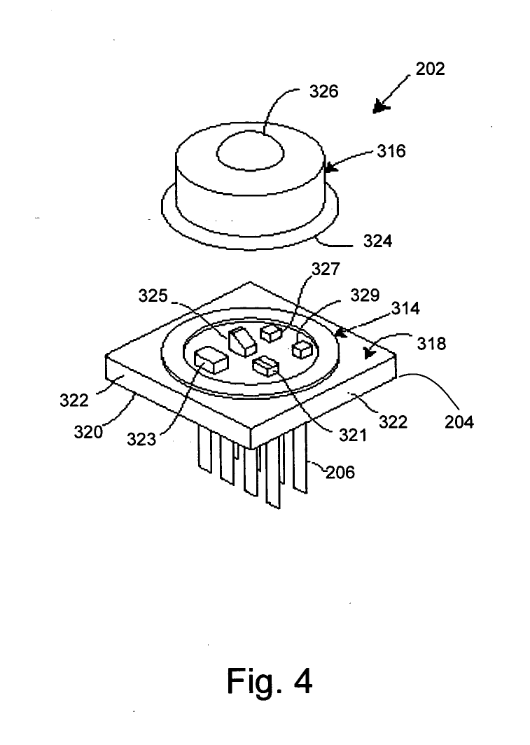

FIG. 4 shows a more detailed view of the TO-can 202 for housing an optoelectronic assembly. The To-can 220 may include insulating base or header 204, a metal sealing member 314, and a metal cover 316. Preferably, the header 204 is formed of a material with good thermal conductivity for directing dissipated heat away from the optoelectronic assembly. By using a high thermal conductivity material, the header 12 may effectively dissipate the heat of un-cooled active optical devices, e.g., diode lasers, and can incorporate integrated circuits, such as diode driver chips.

The insulating header 204 includes an upper surface 318, a lower surface 320, and four substantially flat sidewalls 322 (two of which are shown) extending downwardly from the upper surface 318. The thickness of the header 204 may be approximately 1 mm. Of course, it should be understood that the insulating header 204 may be thicker or thinner as desired. The header 204 may be configured as a multilayer substrate having a plurality of levels. Multiple metal layers may be provided at each of the plurality of levels, and joined together (e.g., laminated).

Various devices may be housed within the TO-can 202. For example, an active optical device 321, such as a VCSEL 321, and its associated integrated circuitry 323, other optical devices 325, such as a photodiode 325, and various other electrical components 327 and 329 may be located within an inner region of the metal sealing member 314.

At least one electrical lead 206 may be included adapted to communicate signals from the optoelectronic and/or electrical components housed inside the package TO-can 202 to components located external to the TO-can 202 on a printed circuit board, for example. The leads 206 may be circular or rectangular in cross-section, as shown. Alternatively, the header 204 may be operatively coupled to a printed circuit board using solder connections such as, for example, ball grid array connections and/or a flex circuit.

The cover 316, may be formed of Kovar™ or other suitable metal, may be hermetically sealed to the metal sealing member 314 to contain and fully enclose the optoelectronic and electrical components mounted to the upper surface 318 of the header 204, and to thereby seal off the TO-can 202. Use of such a hermetically sealed cover 216 acts to keep out moisture, corrosion, and ambient air to protect the generally delicate optoelectronic and electrical components therein.

The cover 316 includes a transparent portion 214 such as, for example, a flat glass window, ball lens, aspherical lens, or GRIN lens. The optoelectronic components, such as the VCSEL 325, are positioned within the TO-can 202 in a manner such that light is able to pass to or from them through the transparent portion 214. Typically, the transparent portion 214 is formed of glass, ceramic, or plastic. To avoid effecting the optoelectronic and electrical components housed within the TO-can 202, the transparent portion 214 of the cover 316 may be provided with an antireflection coating to reduce optical loss and back-reflection.

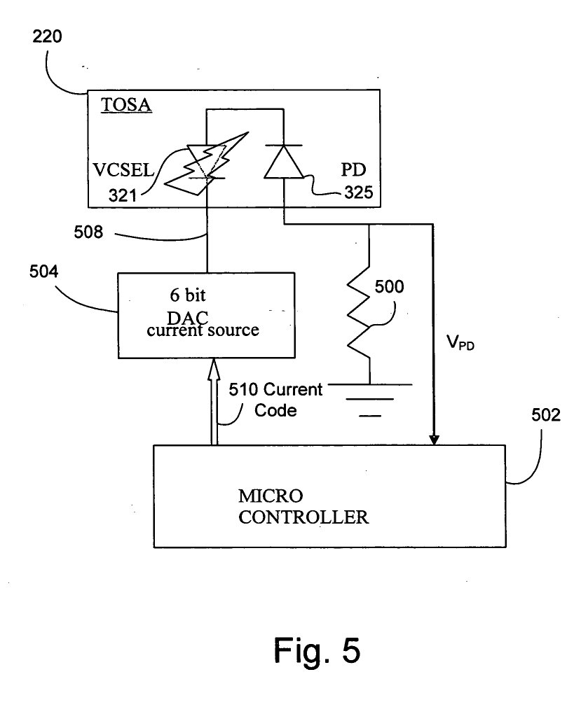

FIG. 5 shows a block diagram of a laser driving circuit according to one embodiment of the invention to determine the laser's excitation ratio (ER) slope in real time in order to adjust parameters to keep the slope substantially constant even as extraneous parameters, such as ambient temperature, varies. In one embodiment, a VCSEL laser 321 may be fashioned in a TOSA 220, such as that shown in FIG. 3, and form part of an optical transceiver 100 such as that shown in FIG. 2. A photo detector (PD) 325 may also be fashioned in the TOSA 220 to detect the output of the VCSEL 321. The photo detector (PD) 325 outputs a signal in response to the detected output of the VCSEL 321. In one embodiment, the output of the PD 325 may be measured by monitoring changes in a voltage V_{PD} across a resistor 500 by a microcontroller 502.

In one embodiment, a digital-to-analog current source (DAC) 504 may be used to provide a drive current to the VCSEL 231. DAC current sources are generally discussed for example in U.S. Pat. No. 5,001,484 to Weiss. The DAC current source 504 may typically be constructed of an array of current source transistors that produce output currents of weighted values that represent bits in a binary word or code 510. High resolution DACs typically employ weighted current sources in which the ratio of the most significant current bit I_{MSB}, to the least significant current bit, I_{LSB}, ranges from 64:1, in the case of an six-bit DAC, to as high as 32,768:1, in the case of a sixteen-bit DAC. In general terms, I_{MSB}/I_{LSB}=2^{(N-1)}, where N is the number of bits.

In one embodiment, as shown in FIG. 5, a 6-bit DAC current source 504 may be used. As shown, the VCSEL driving current 508 may be selected by inputting a 6-bit binary code 510 into the 6-bit DAC 504. The output power of the VCSEL 321 may be monitored by the voltage V_{PD} from the photo detector (PD) 325 which may be located inside the TOSA package 220.

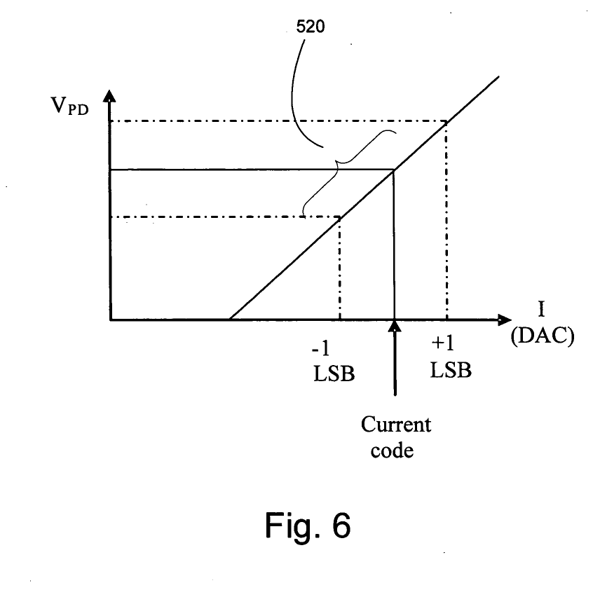

Referring to FIG. 6, the excitation ratio slope may be monitored in real-time by the micro-controller 502. According to an embodiment, the microcontroller 502 may periodically dither (i.e., increase or decrease) the current code 510 by, for example, +/−1 LSB driving current without appreciable interference to the main VCSEL 321 operation. However, slight variation in VSCEL output power caused by this +/−1 LSB change may be detected by an output voltage variation V_{PD} of the PD 325 to reflect the difference in the laser average power. In one embodiment, the microcontroller 502 may increase and decrease the current code 510 by +/−1 LSB for example anywhere from 500-1500 times a second. Of course this number may be selected to be different according to the application. Signal V_{PD} feeds into the microcontroller 502 such that a representation of the excitation ratio slope efficiency 520 may be determined in real time. According to one embodiment, the slope efficiency may be determined by:

$$Slope Efficiency ( η ) = \frac{{V}_{pd} ( current code + 1 LSB ) - {V}_{pd} ( current code - 1 LSB ) .}{I ( current code + 1 LSB ) - I ( current code - 1 LSB )}$$

Knowing real time excitation ratio slope efficiency then allows the microcontroller to adjust the current code to correspondingly adjust the drive current 508 driving the VCSEL 321 to maintain a substantially constant slope over various ambient temperature and conditions, thus eliminating use of EEPROM look-up tables and the drawbacks associated therewith.

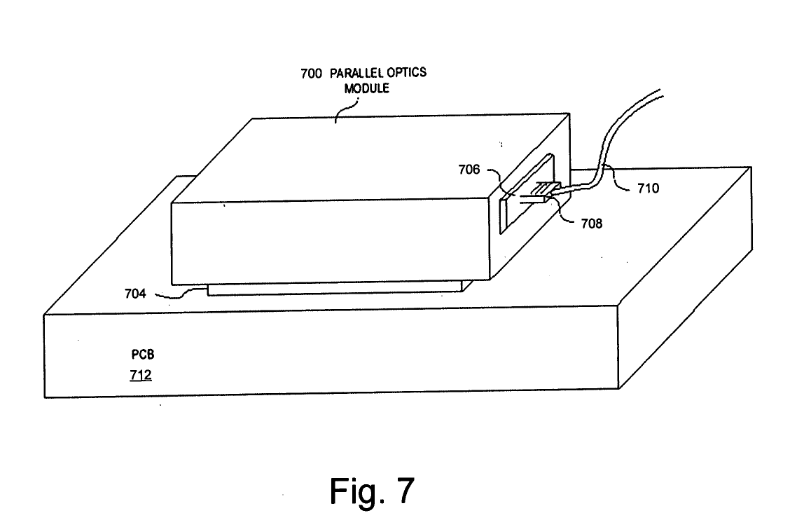

FIG. 7 illustrates embodiments of the invention used in a parallel optics module 700 coupled to a printed circuit board (PCB) 712. Parallel optics module 700 may include drive controls and VCSEL TOSAs as previously described for example with relation to FIG. 5. Parallel optics module 700 may include an optical transmitter, an optical receiver, or an optical transceiver.

Parallel optics module 700 includes an electrical connector 704 to couple module 700 to PCB 712. Electrical connector 704 may include a ball grid array (BGA), a pluggable pin array, a surface mount connector, or the like.

Parallel optics module 700 may include an optical port 706. In one embodiment, optical port 706 may include an optical port comprising for example the SFF connector shown in FIG. 2 or may be adapted to receive a Multi-Fiber Push On (MPO) connector 708. MPO connector 708 may be coupled to an optical fiber ribbon 710. In one embodiment, the optical fiber ribbon 710 includes two or more plastic optical fibers.

In one embodiment, the VCSELs within the parallel optics module 700 may emit light at different wavelengths for use in Wavelength Division Multiplexing (WDM). In one embodiment, parallel optics module 700 may transmit and/or receive optical signals at approximately 850 nanometers (nm). In another embodiment, parallel optics module 700 may operate with optical signals having a transmission data rate of approximately 34 Gigabits per second (Gb/s) per channel. In yet another embodiment, optical signals transmitted and received by parallel optics module 700 may travel up to a few hundred meters. It will be understood that embodiments of the invention are not limited to the optical signal characteristics described herein.

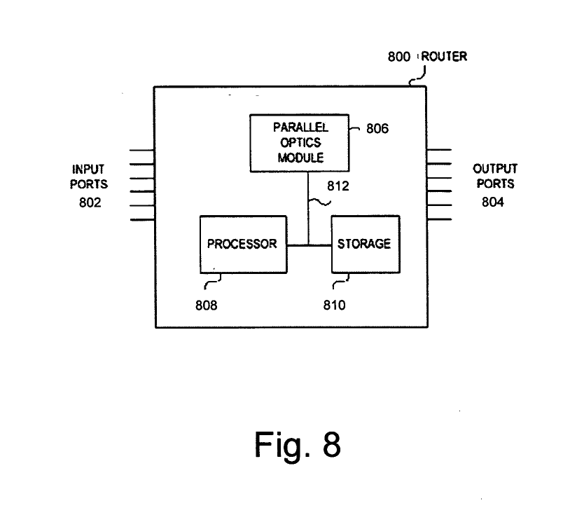

FIG. 8 illustrates an embodiment of a router 800. Router 800 includes a parallel optics module 806 as described above. In another embodiment, router 800 may be a switch, or other similar network element. In an alternative embodiment, parallel optics module 806 may be used in a computer system, such as a server.

Parallel optics module 806 may be coupled to a processor 808 and storage 810 via a bus 812. In one embodiment, storage 810 has stored instructions executable by processor 808 to operate router 800.

Router 800 includes input ports 802 and output ports 804. In one embodiment, router 800 receives optical signals at input ports 802. The optical signals are converted to electrical signals by parallel optics module 806. Parallel optics module 806 may also convert electrical signals to optical signals and then the optical signals are sent from router 800 via output ports 804. According to embodiments of the invention, the ER slope efficiency of the lasers within the router 800 may be maintained in real time across a broad ambient temperature range.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. An apparatus, comprising:
a laser;
a variable current source connected to said laser;
a photo detector to output a signal in response to an output of said laser; and
a controller to vary the output of the current source to the laser and to monitor the signal from the photodiode to determine an excitation ratio slope efficiency for the laser,
wherein the variable current source adjusts drive current to the laser responsive to the calculated excitation ratio slope efficiency.

2. An apparatus as recited in claim 1, wherein the variable current source comprises a digital to analog current (DAC) source having an output current responsive to a binary current code.

3. The apparatus as recited in claim 2 wherein the controller periodically varies the binary current code by +/−1 least significant bit (LSB).

4. The apparatus as recited in claim 3 wherein the controller periodically varies the binary current code 500-1500 times a second.

5. The apparatus as recited in claim 3 wherein a real-time excitation ratio slope efficiency is determined as:
$$Slope Efficiency ( η ) = \frac{{V}_{pd} ( current code + 1 LSB ) - {V}_{pd} ( current code - 1 LSB )}{I ( current code + 1 LSB ) - I ( current code - 1 LSB )} ,$$
where: V_{PD} is the photo detector output signal, and
I is the output of the DAC source.

6. A method for controlling a laser, comprising:
supplying drive current to a laser with a digital to analog current (DAC) source responsive to a binary current code;
varying the binary current code by +/−1 least significant bit (LSB);
monitoring the output of the laser during the varying;
calculating an excitation ratio slope efficiency in real time.

7. The method as recited in claim 6, further comprising:
periodically varying the binary current code 500-1500 times a second.

8. The method as recited in claim 6 further comprising:
adjusting drive current to maintain excitation slope efficiency.

9. The method as recited in claim 6, wherein the monitoring comprises:
monitoring a voltage output signal from a photo detector receiving light output from the laser.

10. The method as recited in claim 9 further comprising:
determining a real-time excitation ratio slope efficiency for the laser by:
$$Slope Efficiency ( η ) = \frac{{V}_{pd} ( current code + 1 LSB ) - {V}_{pd} ( current code - 1 LSB )}{I ( current code + 1 LSB ) - I ( current code - 1 LSB )} ,$$
where: V_{PD} is the photo detector voltage output signal, and
I is current output of the DAC source.

11. The method as recited in claim 9 further comprising:
packaging the laser and the photo detector in a transmitter optical subassembly (TOSA).

12. A system, comprising:
a transmitter optical subassembly (TOSA), comprising at least:
a vertical cavity surface emitting laser (VCSEL); and
a photo detector to monitor an output of the VCSEL; and
a control circuit, comprising:
a variable current source to drive the VCSEL;
a microcontroller to use an output of the of the photo detector to calculate an excitation ratio slope efficiency for the VCSEL in real time as drive current is varied.

13. The system as recited in claim 12 wherein the TOSA and control circuit comprises part of a router.

14. The system as recited in claim 12 wherein the variable current source comprises a digital to analog current source (DAC) to output the drive current according to a binary code from the microcontroller.

15. The system as recited in claim 14 wherein the drive current is varied by changing binary current code by +/−1 least significant bit (LSB).

16. A constant excitation ratio laser driving circuit, comprising:
a transmitter optical subassembly (TOSA) comprising a vertical cavity surface emitting laser (VCSEL) and a light detector;
a digital-to-analog current source (DAC) to supply a drive current to the VCSEL;
a microcontroller to supply a binary code word to the DAC, the DAC outputting a level of drive current according to the binary code word,
wherein the microcontroller to dither the binary code word and monitor an output signal from the light detector to calculate an excitation ratio slope for the VCSEL in real time and select a new binary code word to make the excitation ratio slope substantially constant over changing ambient temperature conditions.

17. The circuit as recited in claim 16, wherein the dither comprises:
the binary current code word varied by +/−1 least significant bit (LSB).

18. The circuit as recited in claim 17, wherein the excitation ratio slope is determined by:
$$Slope Efficiency ( η ) = \frac{{V}_{pd} ( current code + 1 LSB ) - {V}_{pd} ( current code - 1 LSB )}{I ( current code + 1 LSB ) - I ( current code - 1 LSB )} ,$$
where: V_{PD} is the output signal of the photo detector, and
I is current output of the DAC.

19. The circuit as recited in claim 16, further comprising:
a small form factor (SFF) module housing the TOSA.

20. The circuit as recited in claim 19 wherein the SFF module comprises part of an optical transceiver.
